(19) United States
(12) Patent Application Publication
(10) Pub. No.: US 2020/0380586 A1
(43) Pub. Date: Dec. 3, 2020

(54) ON-DEMAND CLOTHING DISTRIBUTION METHOD

(71) Applicants: Joanne Francois, Naples, FL (US); Meronais Exavier, Naples, FL (US)

(72) Inventors: Joanne Francois, Naples, FL (US); Meronais Exavier, Naples, FL (US)

(21) Appl. No.: 16/883,944

(22) Filed: May 26, 2020

Related U.S. Application Data
(60) Provisional application No. 62/853,203, filed on May 28, 2019.

(51) Int. Cl. G06Q 30/06; G06Q 10/08

(52) U.S. Cl. CPC G06Q 30/0633; G06Q 30/0641; G06Q 10/0835; G06Q 10/0833; G06Q 30/0645

(57) ABSTRACT

A method of distributing clothing provides clients with a solution for being delivered clothing on short notice. A potential client is provided with an interface such as a mobile device application which enables the client to select a clothing product and specify a needed delivery time and location. The flexibility of delivery time and location allows clients to order clothing on short notice, for example, if an outfit becomes soiled or damaged, and a suitable replacement is needed on short notice. The clothing product is delivered within the specified timeframe, and the client may choose to either return or purchase the product within 48 hours of reception.

### CROSS-REFERENCE TO RELATED APPLICATION(S)

The present application is related to and claims priority to U.S. Provisional Patent Application No. 62/853,203 filed May 28, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of clothing rental systems of existing art and more specifically relates to clothing delivery and rental or retail systems.

### RELATED ART

Obtaining clothing for special events can be a stressful and difficult process. In-person shopping can be tedious and is limited by the amount of inventory in a retail location. Travel time, changing room time, and in-person returns can make shopping for clothing lengthy and burdensome. Standard rental outlets are not organized to complete orders on short notice. Further, if a customer rents an outfit and decides they want to buy it, they are usually unable to do so from a rental outlet. There is perceived a need for a method which enables expedited and user-friendly selection of clothing on short notice.

U.S. Pat. No. 2013/0151371 to Marisa B. Moss relates to systems and methods for on-line clothing rental. The described systems and methods for on-line clothing rental includes a system, a method, and a computer program for rental of items. An item in a plurality of items can be selected. At least one parameter relating to the selected item and including at least a type of the selected item can be determined. A determination can be made whether a user desires to rent and/or purchase the selected item. If the user desires to rent the selected item, then at least one of the following determinations can be made: whether the selected item is available for rent, a desired rental period during which the selected item is rented out to the user, a rental cost of the selected item to the user based on the determined rental period, whether the user desires to extend the rental period of the selected item, and whether the user wishes to purchase the selected item after expiration of the rental period of the selected item. If the user desires to purchase the selected item, a purchase price of the selected item can be determined. The user can be authorized to rent and/or purchase the selected item and the selected item can be provided to the user. The reference to Moss is representative of prior solutions in the clothing rental art. There is yet seen a need for expedited on-demand delivery solutions that resolve the identified challenges.

### SUMMARY OF THE INVENTION

In view of the foregoing disadvantages inherent in the known clothing rental art, the present disclosure provides a novel on-demand clothing distribution method. The general purpose of the present disclosure, which will be described subsequently in greater detail, is to provide an on-demand clothing distribution method.

A method of distributing clothing is disclosed herein. The method of distributing clothing provides clients with a solution for being delivered selected clothing on short notice. A potential client is provided with an interface such as a mobile device application which enables the client to select a clothing product and specify a needed delivery time and location. The flexibility of delivery time and location allows clients to order clothing on short notice, for example, if an outfit becomes soiled or damaged, and a suitable replacement is needed on short notice. The clothing product is delivered within the specified timeframe, and the client may choose to either return or purchase the product within 48 hours of reception.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an on-demand clothing distribution method, constructed and operative according to the teachings of the present disclosure.

FIG. 1 is a flowchart of the method of distributing clothing according to an embodiment of the disclosure.

FIG. 2 is a view of the method of distributing clothing of FIG. 1, according to an embodiment of the present disclosure.

FIG. 3 is a flowchart of the method of distributing clothing of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a clothing rental and more particularly to an on-demand clothing distribution method as used to improve the expedited delivery of clothing products.

Generally, the on-demand clothing distribution method provides a solution for users which require clothing delivery on short notice with flexible delivery methods and/or flexibility in either renting or purchasing the clothing. The flexibility of the delivery method also makes the method useful to clients for testing clothing in a way that cannot be appreciated merely by trying on clothing in a changing room. The method allows clients to order clothing on short notice in emergencies. For example, a client may be preparing for a momentous occasion and soil or damage a formal outfit. In such a situation, the present method provides a solution for receiving a desired outfit quickly with flexible delivery and return parameters. Delivery may be accomplished by a dedicated driver (as opposed to a delivery service such as the U.S. Postal Service), either an employee or third-party contractor. They delivery may be made to any client-specified location where the client can pick up the clothing product. When used with a software application (and particularly with a mobile device) the method provides further convenience and flexibility in that the client may browse and order in virtually any situation or location.

An express clothing rental delivery service using the method may be engaged via the software application from an electronic device. The service may allow a customer to select and order clothing of their choice, and delivery of such within a short, same day time-frame. It eliminates the stress associated with accidentally soiling an article of clothing prior to a special event or outing. Preferably, the service is accessible via a website. The system may include a server database presenting clothing for rent, and a user interface allowing a user to choose clothing, input their delivery and payment information, and have it shipped to them same day. Upon delivery, the user may wear the clothing and may be provided with a timeframe of 48 hours to decide whether to return or buy.

For the purposes of this specification, “localized” indicates at least within the same county. Preferably, the elements of this methodology (i.e. the location of the warehouse is relative to the client) is localized to cities. For example, the order a client ordering clothing in Sacramento will preferably be routed to a warehouse in Sacramento if prompt delivery is required by the client.

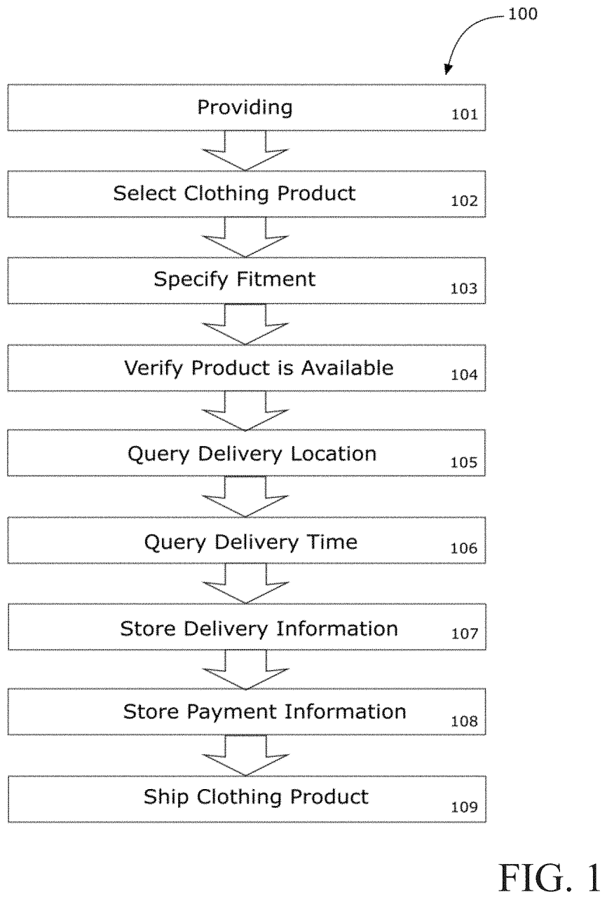

Referring now more specifically to the drawings by numerals of reference, there is shown in FIGS. 1-4, various views of a method of distributing clothing 100.

FIG. 1 shows a flowchart of a method of distributing clothing 100 according to an embodiment of the present disclosure. Here, the method of distributing clothing may be beneficial for use by a user or client for expedited delivery of clothing products as needed by the client. As illustrated, the method of distributing clothing 100 may include: providing a clothing-selection interface accessible by a client-account associated with a client 101; selecting a clothing product to be delivered 102; specifying a fitment 103; verifying if a selected clothing product is available for delivery 104; querying a delivery location 105; querying a delivery time 106; storing delivery information associated with the client, the delivery information comprising the delivery location and the delivery time 107; processing and/or storing payment information associated with the client 108; and shipping clothing product 150 from a warehouse to the client 109.

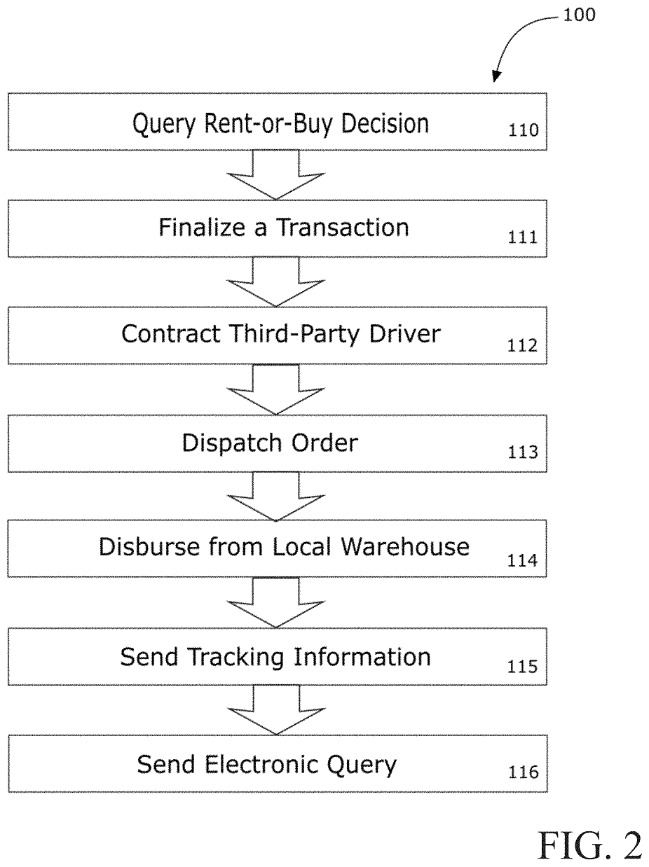

FIG. 2 is a flowchart of the method of distributing clothing of FIG. 1, according to an embodiment of the present disclosure. As shown, additional steps may include and querying a rent-or-buy decision within forty-eight hours after shipping clothing product to the client 110. Querying a rent-or-buy decision may be enacted by sending an electronic message 116 prompting the client to select a return and alternatively to electronically purchase the clothing process. Further steps may include finalizing a transaction 111, and sending tracking information 115. In some embodiments, the method may also include the step of contracting a third-party delivery driver to deliver clothing product to the client 112. Yet further steps may include dispatching an order request from the server to a localized warehouse client-side receiver 113, and disbursing clothing product from a localized warehouse 114.

It should be understood that the order of the steps as illustrated in these figures represent an ideal embodiment. In some embodiments, some steps may be omitted or reordered.

In some embodiments, the software application may include delivery-tracking updates, navigable retail product pages, and a map illustrating selectable warehouse locations. In some embodiments, the warehouse from which clothing product 150 is shipped can be automatically selected based upon availability of clothing product 150 and the proximity of the warehouse to the delivery location indicated by the client.

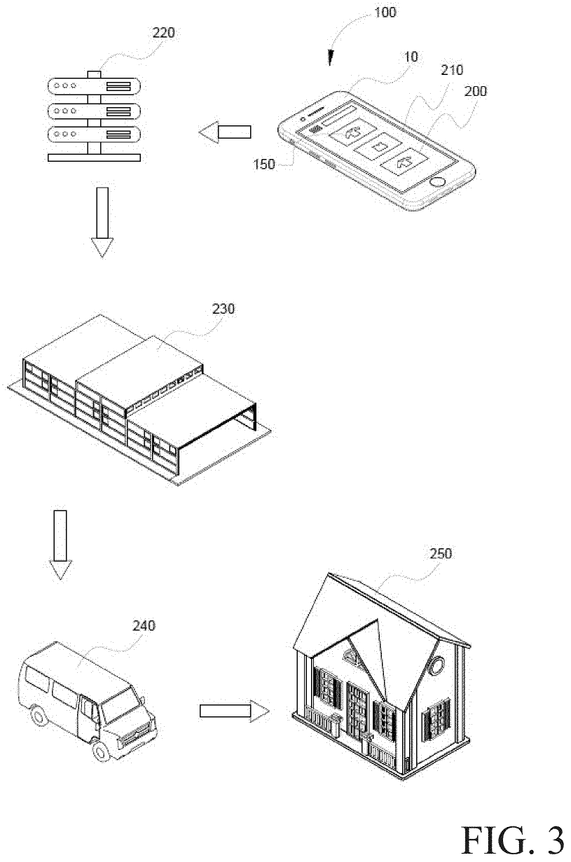

FIG. 3 shows the method of distributing clothing of FIG. 1 in effect, according to an embodiment of the present disclosure. As shown, clothing-selection interface 200 may include a software application 210. In some embodiments (or in required situations) storing delivery information associated with the client and storing payment information associated with the client may be accomplished automatically by a server 220 when the client logs into their client-account or when the transaction is finalized (for example, if the client does not explicitly specify a pick-up/delivery location).

In an exemplary embodiment, the client may choose to either return clothing product 150 within forty-eight hours of shipping clothing product 150 to the client, or to purchase clothing product 150. If required by the client, shipping clothing product 150 to the client may be completed within the same business day as specifying a clothing product to be delivered provided that the clothing product 150 to be delivered is ordered by a predetermined time (i.e. 3 PM). The client may respond to querying a delivery time by requesting a delivery time in as little as thirty minutes. Querying the delivery times requires a response ranging from within half an hour of finalizing the transaction to forty-eight hours of finalizing the transaction.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method of distributing clothing comprising:
providing a clothing-selection interface accessible by a client-account associated with a client;
selecting a clothing product to be delivered;
specifying a fitment;
querying a delivery location;
querying a delivery time;
storing delivery information associated with the client, the delivery information comprising the delivery location and the delivery time;
processing payment information associated with the client;
finalizing a transaction;
shipping the clothing product from a warehouse to the client; and
querying a rent-or-buy decision within forty-eight hours after shipping the clothing product to the client, whereby the client may choose to either return the clothing product within forty-eight hours of shipping the clothing product to the client, or to purchase the clothing product.

2. The method of distributing clothing of claim 1, wherein shipping the clothing product to the client is completed within the same business day as specifying a clothing product to be delivered if specifying a clothing product to be delivered is completed by a predetermined time.

3. The method of distributing clothing of claim 1, wherein the clothing-selection interface comprises a software application.

4. The method of distributing clothing of claim 1, wherein storing delivery information associated with the client and storing payment information associated with the client is accomplished automatically by a server when the client logs in to the client-account.

5. The method of distributing clothing of claim 1, further comprising the step of
verifying if a selected clothing product is available for delivery.

6. The method of distributing clothing of claim 1, wherein querying a rent-or-buy decision is enacted by sending an electronic message prompting the client to select a return and alternatively to electronically purchase the clothing process.

7. The method of distributing clothing of claim 1, wherein a client may respond to querying a delivery time by requesting a delivery time in as little as thirty minutes.

8. The method of distributing clothing of claim 1, further comprising the step of contracting a third-party delivery driver to deliver the clothing product to the client.

9. The method of distributing clothing of claim 1, further comprising the steps of
dispatching an order request from the server to a localized warehouse client-side receiver; and
disbursing the clothing product from a localized warehouse.

10. The method of distributing clothing of claim 1, wherein querying the delivery times requires a response ranging from within one hour of finalizing the transaction to forty-eight hours of finalizing the transaction.

11. The method of distributing clothing of claim 1, wherein the software application comprises delivery-tracking updates.

12. The method of distributing clothing of claim 1, wherein the software application comprises retail product pages.

13. The method of distributing clothing of claim 1, wherein the software application comprises a map illustrating warehouse locations enabling optional selection of a warehouse.

14. The method of distributing clothing of claim 1, wherein the warehouse from which the clothing product is shipped is automatically selected based upon
availability of the clothing product; and
proximity of the warehouse to the delivery location indicated by the client.

15. An expedited method of distributing clothing for rental or retail, the expedited method of distributing clothing comprising:
providing a clothing-selection interface accessible by a client-account associated with a client;
selecting a clothing product to be delivered;
specifying a fitment;
verifying if a selected clothing product is available for delivery;
querying a delivery location;
querying a delivery time;
storing delivery information associated with the client, the delivery information comprising the delivery location and the delivery time;
processing payment information associated with the client;
finalizing a transaction;
dispatching an order request from the server to a localized warehouse client-side receiver;
disbursing the clothing product from a localized warehouse;
shipping the clothing product from a warehouse to the client; and
querying a rent-or-buy decision within forty-eight hours after shipping the clothing product to the client, whereby the client may choose to either return the clothing product within forty-eight hours of shipping the clothing product to the client, or to purchase the clothing product.
wherein the clothing-selection interface comprises a software application.
wherein querying a rent-or-buy decision is enacted by sending an electronic message prompting the client to select a return and alternatively to electronically purchase the clothing process;
wherein a client may respond to querying a delivery time by requesting a delivery time in as little as thirty minutes; and
wherein the warehouse from which the clothing product is shipped is automatically selected based upon
availability of the clothing product; and
proximity of the warehouse to the delivery location indicated by the client.

16. The expedited method of distributing clothing for rental or retail of claim 15, wherein
the software application comprises delivery-tracking updates; and
the software application further comprises retail product pages.
